(19) United States
(12) Patent Application Publication
(10) Pub. No.: US 2017/0236091 A1
(43) Pub. Date: Aug. 17, 2017

(54) DELIVERY ESTIMATES WITH IMPROVED ACCURACY

(71) Applicant: Wal-Mart Stores, Inc., Bentonville, AR (US)

(72) Inventors: Sai Phaneendra Sri Harsha Viswanath Putcha, Bentonville, AR (US); Kerry D. Melton, Springdale, AR (US)

(21) Appl. No.: 15/427,776

(22) Filed: Feb. 8, 2017

Related U.S. Application Data
(60) Provisional application No. 62/293,976, filed on Feb. 11, 2016.

(51) Int. Cl. G06Q 10/08; G01C 21/34; H04L 12/58

(52) U.S. Cl. CPC G06Q 10/0833; H04L 51/10; G01C 21/343

(57) ABSTRACT

A driver computer transmits notifications of arrival at destinations and possibly other notifications indicating departure or other actions. Based on these notifications the drop off delay required to make the delivery is estimated. The drop off delays for a destination are combined to arrive at a drop off estimate. The estimated arrival time at a destination in a route is then calculated as the estimated travel times to and between preceding destinations plus the drop off estimates for the preceding destinations. Drop off estimates may include a range of likely drop off times such that the estimated arrival time includes arrange of likely arrival times. The estimated arrival time is transmitted to recipients of the deliveries. The estimated arrival time may be updated based on actual delivery times and the updated arrival time transmitted to the recipients.

### RELATED APPLICATIONS

This application claims the priority benefit of U.S. of America Application No. 62/293,976 filed Feb. 11, 2016.

### BACKGROUND

Field of the Invention

This invention relates to systems and methods for managing deliveries.

Background of the Invention

Many of a typical consumer's purchases are made online. Even everyday items are often purchased online and delivered. However, theft of unattended packages is also a growing problem. For expensive items, a consumer may wish to be at the delivery location at or shortly after delivery in order to prevent theft. In some instances, a consumer signature may be required. However, when a delivery actually occurs is highly unpredictable. Often a very large window on the order of two or more hours is provided. This can be highly inconvenient for a customer.

An improved approach to providing estimated delivery times is disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a network environment suitable for implementing embodiments of the invention;

FIG. 2 is a schematic block diagram of an example computing device suitable for implementing methods in accordance with embodiments of the invention;

FIG. 3 is a process flow diagram of a method for calculating delay estimates in accordance with an embodiment of the present invention; and

FIG. 4 is a process flow diagram of a method for calculating a delivery time estimate in accordance with an embodiment of the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

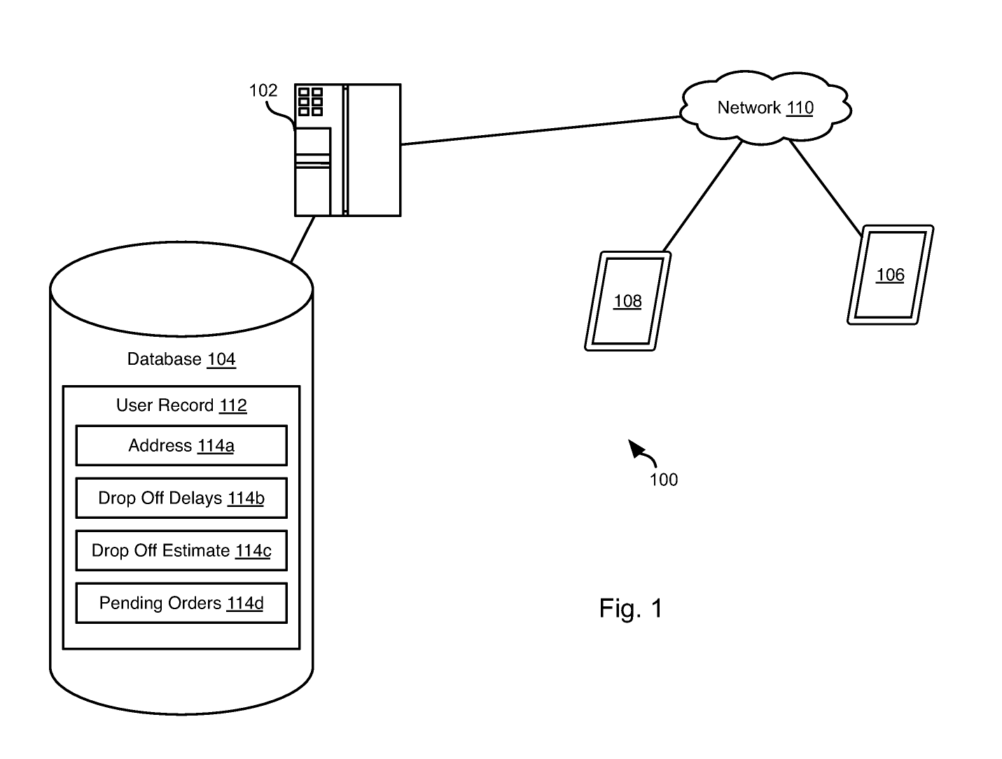

Referring to FIG. 1, a network environment 100 may be used to implement methods as described herein. The environment 100 may include a server system 102 associated with an entity. The server system 102 may host or access one or more databases 104 and interact with one or more driver computers 106. The driver computer 106 may be a mobile phone, tablet computer, desktop computer, laptop computer, or other type of computing device.

The driver computers 106 may receive updates to statuses of deliveries by a driver and transmit these updates to the server system 102. Status updates regarding a delivery may include, for example, a notification the driver has arrived at a delivery location (“driver arrived message”), a notification that the driver has dropped off a package at the delivery location (“package delivered message”), and a notification that the driver has returned to the vehicle and is en route to a next destination (“driver en route message”). In some embodiments, the driver computer 106 may also transmit its current location periodically or in response to a driver invoking one of the status updates.

Although a “driver” and a driver computer 106 are mentioned throughout, the computer 106 may function in an identical manner for deliveries made by a courier on foot or riding a bicycle.

A user computer 108, such as a mobile phone, tablet computer, desktop computer, or laptop computer may also be in communication with the server system 102 and receive notifications of an estimated delivery time from the server system 102, where the estimated delivery time is determined according to the methods disclosed herein.

The driver computer 106 and user computer 108 may be in data communication with the server system 102 by means of a network 110, such as a local area network (LAN), wide area network (WAN), the Internet, or any other wired or wireless network connection.

The database 104 may store some or all of the data shown in a user record 112. Each user record 112 may correspond to a recipient of at least one delivery that has been completed or is scheduled to be completed. The user record 112 may include a street address 114a of the user. The user record 112 may further include drop off delays 114b for the user as measured according to the methods disclosed herein. The user record 112 may include a drop off estimate 114c that is a statistical estimate of a likely drop off time for the user as determined according to the methods disclosed herein. The user record 112 may further include one or more pending orders 114d of the user. The pending orders may list products ordered and the status thereof (e.g., pending, ready to ship, a scheduled shipping date, or the like).

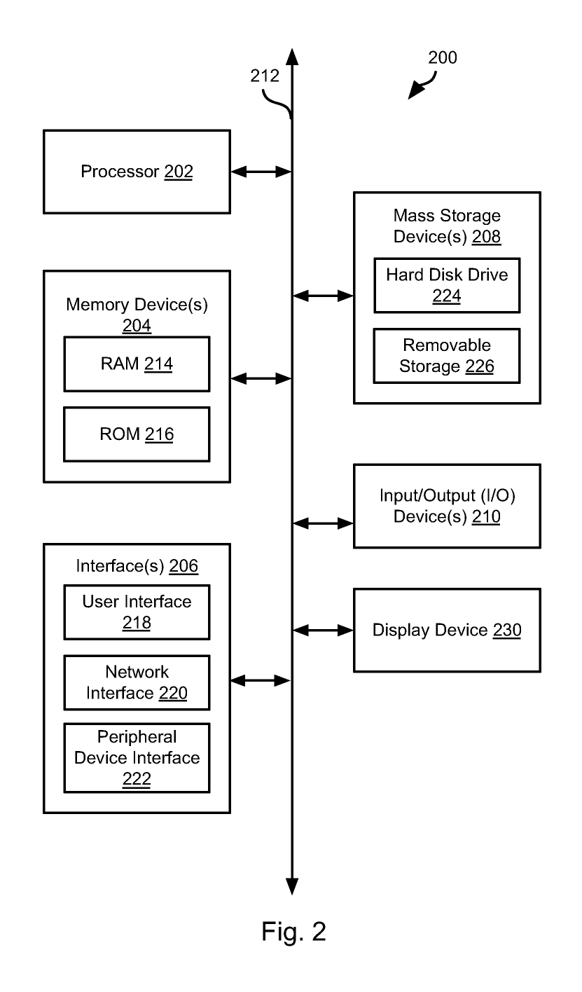

FIG. 2 is a block diagram illustrating an example-computing device 200. Computing device 200 may be used to perform various procedures, such as those discussed herein. The server system 102, driver computer 106, and user computer 108 may have some or all of the attributes of the computing device 200. Computing device 200 can function as a server, a client, or any other computing entity. Computing device can perform various monitoring functions as discussed herein, and can execute one or more application programs, such as the application programs described herein. Computing device 200 can be any of a wide variety of computing devices, such as a desktop computer, a notebook computer, a server computer, a handheld computer, a tablet computer and the like. The server system 102 may include one or more computing devices 200 each including one or more processors.

Computing device 200 includes one or more processor(s) 202, one or more memory device(s) 204, one or more interface(s) 206, one or more mass storage device(s) 208, one or more Input/Output (I/O) device(s) 210, and a display device 230 all of which are coupled to a bus 212. Processor(s) 202 include one or more processors or controllers that execute instructions stored in memory device(s) 204 and/or mass storage device(s) 208. Processor(s) 202 may also include various types of computer-readable media, such as cache memory.

Memory device(s) 204 include various computer-readable media, such as volatile memory (e.g., random access memory (RAM) 214) and/or nonvolatile memory (e.g., read-only memory (ROM) 216). Memory device(s) 204 may also include rewritable ROM, such as Flash memory.

Mass storage device(s) 208 include various computer readable media, such as magnetic tapes, magnetic disks, optical disks, solid-state memory (e.g., Flash memory), and so forth. As shown in FIG. 2, a particular mass storage device is a hard disk drive 224. Various drives may also be included in mass storage device(s) 208 to enable reading from and/or writing to the various computer readable media. Mass storage device(s) 208 include removable media 226 and/or non-removable media.

I/O device(s) 210 include various devices that allow data and/or other information to be input to or retrieved from computing device 200. Example I/O device(s) 210 include cursor control devices, keyboards, keypads, microphones, monitors or other display devices, speakers, printers, network interface cards, modems, lenses, CCDs or other image capture devices, and the like.

Display device 230 includes any type of device capable of displaying information to one or more users of computing device 200. Examples of display device 230 include a monitor, display terminal, video projection device, and the like.

Interface(s) 206 include various interfaces that allow computing device 200 to interact with other systems, devices, or computing environments. Example interface(s) 206 include any number of different network interfaces 220, such as interfaces to local area networks (LANs), wide area networks (WANs), wireless networks, and the Internet. Other interface(s) include user interface 218 and peripheral device interface 222. The interface(s) 206 may also include one or more peripheral interfaces such as interfaces for printers, pointing devices (mice, track pad, etc.), keyboards, and the like.

Bus 212 allows processor(s) 202, memory device(s) 204, interface(s) 206, mass storage device(s) 208, I/O device(s) 210, and display device 230 to communicate with one another, as well as other devices or components coupled to bus 212. Bus 212 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 200, and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

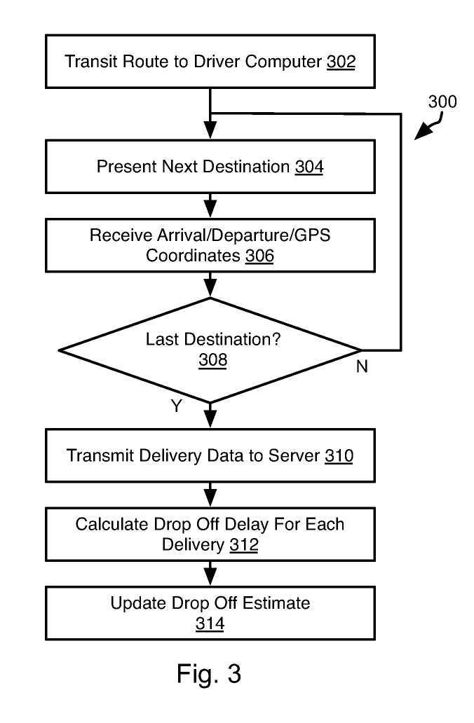

Referring to FIG. 3 the network environment 100 may implement and/or execute the illustrated method 300. The method 300 may be executed by the server system 102 in combination with a driver computer 106 for each delivery route, e.g. a shift's deliveries for a driver associated with the driver computer 106.

The method 300 may include transmitting 302 a route to the driver computer 106. The route may be planned according to an algorithm that reduces travelling time. Accordingly, the deliveries in the route may be arranged in a particular order in which they are to be completed. The method 300 includes presenting 304 a next uncompleted delivery (“current delivery”) from the route on the driver computer. For the first delivery of a shift, this will be the first delivery in the route. In particular, the address for the current delivery may be presented along with an identifier of the package to be delivered at that address. Presenting 304 the current delivery (i.e., next destination) may include presenting driving directions instructing the driver how to arrive at the address of the current delivery.

The method 300 may then include receiving 306 one or more notifications with respect to the current delivery from the driver computer 106. This may include some or all of the “driver arrived message,” “package delivered message,” “driver en route message,” and the GPS coordinates of the driver computer 106. Each message may include a time it was sent by the driver computer 106. The driver may invoke sending of the messages by providing an input to the driver computer 106 instructing it to send the message.

Subsequent to receiving an update indicating that the current delivery has been delivered or is otherwise no-longer being handled by the driver (e.g. delivery failed), the method 300 may include evaluating 308 whether the current delivery was the last destination in the route. If not, then the method continues at step 304 with the next uncompleted delivery on the route.

Steps 310-314 may then be performed with respect to some or all of the deliveries reported as completed at step 306. Steps 310-314 are shown in FIG. 3 as being performed after all deliveries have been handled. However, steps 310-314 may be performed at any time, including after a delivery is completed but before a subsequent delivery in the route is completed.

The method 300 may include transmitting 310 delivery data to the server system 102. The delivery data may include some or all of the messages received at step 306 for each delivery.

The drop off delay for some or all of the deliveries may then be calculated 312. Various approaches may be used to calculate the drop off delay for a delivery depending on the amount of information provided by the messages received at step 306 for the delivery.

In a first case, only a “driver arrived message” is received that includes an arrival time t1 for the destination d1. A second “driver arrived message” includes a time t2 for the next destination (d2) in the route. An estimated travel time T between d1 and d2 is calculated based on the driving distance therebetween and possibly based on current or estimated current traffic conditions. The estimation of the travel time T may be performed using any method known in the art for estimating travel time. An estimate of the drop off delay (D) may be calculated 312 as D=(t2-t1)−T, such that the difference in the actual time delay between arrival times (t2-t1) and the estimated travel time T is attributed to the drop off delay.

In a second case, a “driver arrived message” and a “driver en route message” are received for a destination. Where t1 is the time included in the “driver arrived message” message and t2 is the time included in the first “driver en route message” received after the “driver arrived message,” then the drop off delay D may be calculated as D=t2-t1.

In a third case, the GPS coordinates of the driver computer are transmitted periodically, e.g. one, two, or N times per minute. In such embodiments, the drop off delay for a destination may be determined based on the coordinates, e.g. an amount of time during which the GPS coordinates are within some threshold distance of the destination during delivery. Alternatively, the drop off delay for a delivery may be the time elapsed during which the GPS coordinates indicate movement at less than a driving velocity, e.g. less than 10 miles per hour or some other maximum speed of a driver walking a delivery to a door step or other drop off location.

For some or all of the deliveries on a route, the drop off estimate 114c for the destination of the delivery may be updated 314. For example, the drop off estimate 114c for a user may be an average of all, or the most recent N, drop off delays for the address of the user. Accordingly, the average value A may be updated for each measured delay: A=(A+D)/(M+1), where D is the most recent measured drop off delay and M is the number of previously received drop off delays used to calculate the previous value of A.

In some other embodiments, updating 314 the drop off estimate may include updating some other statistical characterization of the previously received drop off delays.

For example, the standard deviation, the 75^{th} percentile, 25^{th} percentile, or some other percentile of the drop off delays may be calculated based on the most recent drop off delay and previously received drop off delays. In this manner, a drop off estimate may be characterized as a range of likely values X to Y, such that the drop off delay has a high probability (e.g. 90%, 95%, or some other probability) of falling between the X and Y values.

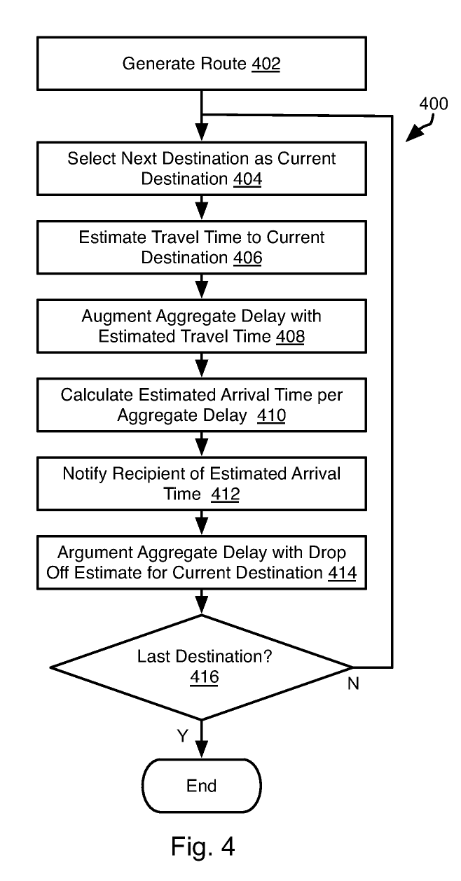

Referring to FIG. 4 the network environment 100 may implement and/or execute the illustrated method 400. The method 400 may be executed by the server system 102. The method 400 may include generating 402 a route. The route may be a set of destinations as well as an ordering of destinations. The route may also include driving directions between consecutive destinations. The route may be determined using any algorithm known in the art for reducing travel time required to visit a set of destinations. The algorithm may distribute deliveries among multiple drivers such that generating 402 a route is part of a process of generating a plurality of routes including the route that is the subject of the subsequent steps of the method 400. In some embodiments, the drop off estimates 114c for the recipients of the deliveries may be used to generate 402 the route. For example, the travel time between destinations and the drop off estimates may be used to determine how many deliveries a driver is likely to complete in a particular shift and the deliveries assigned among drivers accordingly.

The method 400 may include processing each destination in the order specified in the route according to steps 404-414. In particular, a next destination is selected 404 (the first on the list for the first iteration of steps 404-414) as the current destination being processed. The travel time to the current destination is estimated. For the first destination in the route, estimating 406 the travel time may include the travel time from a processing center or other start point for the route. For subsequent destinations, the estimated travel time is an estimate of the time required to travel from a previous destination to the current destination. The estimation of travel time may be performed using any method known in the art for estimating travel time and may take into account current or expected traffic or weather conditions as known in the art.

The method 400 may include augmenting 408 an aggregate delay with the estimated travel time, e.g. G=G+E, where G is the aggregate delay and E is the estimated travel time from step 406. The aggregate delay may be initialized to zero before performing step 408 for the first time with respect to a route.

The method 400 may include calculating 410 an estimated arrival time according to the aggregate delay. For example, the estimated arrival time may be calculated as the expected start time for the route, e.g. a time of departure from the start point, plus the aggregate delay.

The recipient for the current delivery may then be notified 412 of the estimated arrival time, such as by means of a message sent to the user computer 108 of the recipient of the current delivery.

The method 400 may further include augmenting 414 the aggregate delay with the drop off estimate 114c for the current delivery, e.g. G=G+A, where A is the drop off estimate 114c. In some embodiments, a drop off estimate may include a low estimate AL and a high estimate AH, representing a range of values including a high percentage of measured drop off delays, e.g. 90%, 95%, or some other percentage.

Accordingly, two aggregate delays may be maintained, GL and GH. For each iteration of step 408, both aggregate delays may be augmented: GL=GL+E, GH=GH+E. For each iteration of step 414, both aggregate delays may also be augmented: GL=GL+AL, GH=GH+AH. In such embodiments, two estimated arrival times may be calculated at step 410 according to the two aggregate delays AL and AH and the start time (AL+start time, AH+start time), thereby providing a window of likely arrival times. These two arrival times or other representation of the likely arrival window may likewise be transmitted to the recipient at step 412.

If the current destination is found 416 to be the last destination, then the method 400 ends. If not, the next destination in the list is processed starting at step 404. In some embodiments, the method 400 is performed repeatedly. For example, steps 404-414 may be performed for uncompleted deliveries after each completed delivery with the start time being set to the time of completion of the most recently completed delivery of a route. In this manner recipients will receive updated estimates as the route is followed and be notified as soon as possible about any delays or if deliveries are made earlier than expected.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A method comprising:
transmitting, by a server system, to a first driver computer, a first route including a first destination set from a plurality of destinations;
receiving, by the server system, for each destination in the first destination set, an arrival time;
determining, by the server system, a drop off delay for a delivery to the each destination of the destination set according to the arrival time for the each destination and updating, by the server system, a drop off estimate for the each destination using the drop off delay;
transmitting, by the server system, to one of the first driver computer and a second driver, a second route including a second destination set;
for at least one destination in the second destination set, estimating, by the server system, a delay time according to (a) estimated travel times to each destination preceding the at least one destination and to the at least one destination and (b) the drop off estimates for each destination preceding the at least one destination; and
transmitting, by the server system, an estimated arrival time to a recipient for the at least one destination, the estimated arrival time being calculated according to the delay time.

2. The method of claim 1, wherein determining, by the server system, the drop off delay for each destination of the destination set according to the arrival time for the each destination comprises:
receiving, by the server system, from the first driver computer, a notification of a completion time of the delivery to the each destination; and
calculating, by the server system, the drop off delay as a difference between the arrival time and the completion time.

3. The method of claim 2, further comprising, for each destination of the plurality of destinations, updating the drop off estimate for the each destination in response to receiving arrival times for a plurality of deliveries to the each destination.

4. The method of claim 3, wherein updating the drop off estimate for the each destination in response to each delivery to the each destination comprises computing an average of all drop off delays for each delivery of the plurality of deliveries to the each destination.

5. The method of claim 4, wherein estimating the delay time further comprises:
calculating the delay time as a range of delay times according to the estimated travel times and standard deviations of the drop off delays for each destination preceding the at least one destination.

6. The method of claim 1, wherein determining, by the server system, the drop off delay for each destination of the destination set according to the arrival time for the each destination comprises:
calculating a first delay as an estimated travel time between the each destination and a subsequent destination in the first destination set;
calculating a second delay as a difference between the arrival time for the subsequent destination and the arrival time for the each destination; and
calculating the drop off delay as a difference between the second delay and the first delay.

7. The method of claim 1, wherein the first driver computer is a mobile computing device.

8. The method of claim 1, wherein transmitting the estimated arrival time to the recipient for the at least one destination comprises transmitting the estimated arrival time to a mobile device associated with the recipient for the at least one destination.

9. The method of claim 1, wherein transmitting the estimated delivery time to the recipient for the at least one destination is performed prior to receiving arrival times for destinations of the second destination set.

10. The method of claim 1, further comprising selecting destinations of the second destination set according to the drop off estimates of the destinations of the second destination set.

11. A system comprising one or more processors and one or more memory devices operably coupled to the one or more processors, the one or more memory devices storing executable code effective to cause the one or more processors to:
transmit to a first driver computer, a first route including a first destination set from a plurality of destinations;
receive, for each destination in the first destination set, an arrival time;
determine a drop off delay for a delivery to the each destination of the destination set according to the arrival time for the each destination and update a drop off estimate for the each destination using the drop off delay;
transmit to one of the first driver computer and a second driver, a second route including a second destination set;
for at least one destination in the second destination set, estimate a delay time according to (a) estimated travel times to each destination preceding the at least one destination and to the at least one destination and (b) the drop off estimates for each destination preceding the at least one destination; and
transmit an estimated arrival time to a recipient for the at least one destination, the estimated arrival time being calculated according to the delay time.

12. The system of claim 11, wherein the executable code is further effective to cause the one or more processors to determine the drop off delay for each destination of the destination set according to the arrival time for the each destination by:
receiving from the first driver computer, a notification of a completion time of the delivery to the each destination; and
calculating the drop off delay as a difference between the arrival time and the completion time.

13. The system of claim 12, wherein the executable code is further effective to cause the one or more processors to, for each destination of the plurality of destinations, update the drop off estimate for the each destination in response to receiving arrival times for a plurality of deliveries to the each destination.

14. The system of claim 13, wherein the executable code is further effective to cause the one or more processors to update the drop off estimate for the each destination in response to each delivery to the each destination comprises computing an average of all drop off delays for each delivery of the plurality of deliveries to the each destination.

15. The system of claim 14, wherein the executable code is further effective to cause the one or more processors to estimate the delay time by:
calculating the delay time as a range of delay times according to the estimated travel times and standard deviations of the drop off delays for each destination preceding the at least one destination.

16. The system of claim 11, wherein the executable code is further effective to cause the one or more processors to determine the drop off delay for each destination of the destination set according to the arrival time for the each destination by:
calculating a first delay as an estimated travel time between the each destination and a subsequent destination in the first destination set;
calculating a second delay as a difference between the arrival time for the subsequent destination and the arrival time for the each destination; and
calculating the drop off delay as a difference between the second delay and the first delay.

17. The system of claim 11, wherein the first driver computer is a mobile computing device.

18. The system of claim 11, wherein the executable code is further effective to cause the one or more processors to transmit the estimated arrival time to the recipient for the at least one destination by transmitting the estimated arrival time to a mobile device associated with the recipient for the at least one destination.

19. The system of claim 11, wherein the executable code is further effective to cause the one or more processors to transmit the estimated delivery time to the recipient for the at least one destination prior to receiving arrival times for destinations of the second destination set.

20. The system of claim 11, wherein the executable code is further effective to cause the one or more processors to select destinations of the second destination set according to the drop off estimates of the destinations of the second destination set.
